(19) United States
(12) Patent Application Publication
(10) Pub. No.: US 2005/0144077 A1
(43) Pub. Date: Jun. 30, 2005

(54) Apparatus for point system that provides real-time cashback

(75) Inventor: Keiji Takakura, Tokyo (JP)

Correspondence Address: CARRIER BLACKMAN AND ASSOCIATES, 24101 NOVI ROAD, SUITE 100, NOVI, MI, 48375, US

(73) Assignee: HONDA MOTOR CO., LTD., Tokyo (JP)

(21) Appl. No.: 11/021,226

(22) Filed: Dec. 23, 2004

(30) Foreign Application Priority Data
Dec. 26, 2003 (JP) 2003-431929

(51) Int. Cl. G06F 17/60; H04K 1/00; H04L 9/00

(52) U.S. Cl. 705/14; 705/39

(57) ABSTRACT

A cashback system is composed of an IC card storing point data representative an amount of points used for a point system and electronic money data representative of an amount of electronic money, a terminal including a reader/writer accessible to the IC card, a point management server, and an electronic money server. The terminal is programmed to provide a prompt to input a customer ID identifying a customer, and a password in response to establishment of an access between the IC card and the terminal, to provide another prompt to input customer-specific information in response to the identifier and the password being inputted, and to transmit the customer ID, the password, and the customer-specific information to the point management server. The point management server is programmed to issue a conversion allowance when the customer is successfully authenticated with the customer ID, the password, and the customer-specific information. The electronic money server is programmed to determine an amount of electronic money for points selected to be converted by the customer in response to the conversion allowance, and to transfer the determined amount of electronic money to the IC card.

### BACKGROUND OF THE INVENTION

1. Field of the Invention

The present invention is related to systems and methods for providing cashback for “points” in the form of electronic money.

2. Description of the Related Art

As disclosed in Japanese Open Laid Patent Applications No. 2002-170064A, and 2002-109570A, the point system is one of the well-known methods for boosting sales, which gives purchasers “points” for purchase of products or charged services, and provides various special services for the points, such as cashback, and discount. The given “points” are typically accumulated in point cards issued by the selling entity, which are often composed of IC cards incorporating an IC chip. Airline companies, for example, often provide mileage services, which give the users “points” on the basis of the traveling distance.

One requirement is that “points” are allowed to be used for purchase at stores or shops run by entities other than the point issuing entity. Cashback is one approach satisfying such requirement, as disclosed in Japanese Open Laid Patent Application No. 2002-117351A. Cashback based on the “points” is often achieved by using electronic money rather than actual money due to the improved convenience; “points” are converted into corresponding electronic money in accordance with the user's choice.

Converting “points” into the electronic money, however, requires examining whether the user legally obtains the points. This is especially the case when the electronic money is allowed to be used for purchase at entities other than the point issuing entity.

The examination of the legality of the accumulated points is desirably performed as soon as possible after the user's request; this would encourage users to convert “points” into electronic money for purchasing articles, and effectively promote the use of the cashback system.

There is a need for providing a system that allows converting points accumulated in point cards into the electronic money immediately after the user's requirement.

### SUMMARY OF THE INVENTION

Therefore, one object of the present invention is to provide a system that achieves converting points accumulated in point cards into the electronic money immediately after the user's requirement.

In an aspect of the present invention, a cashback system is composed of an IC card storing point data representative an amount of points used for a point system and electronic money data representative of an amount of electronic money, and electronic money data representative of an amount of electronic money; a terminal including a reader/writer accessible to the IC card; a point management server; and an electronic money server. The terminal is programmed to provide a prompt to input a customer ID identifying a customer, and a password in response to establishment of an access between the IC card and the terminal, to provide another prompt to input customer-specific information in response to the identifier and the password being inputted, and to transmit the customer ID, the password, and the customer-specific information to the point management server. The point management server is programmed to issue a conversion allowance when the customer is successfully authenticated with the customer ID, the password, and the customer-specific information. The electronic server is programmed to determine an amount of electronic money for points selected to be converted by the customer in response to the conversion allowance, and to transfer the determined amount of electronic money to the IC card.

When the point management server includes a database containing an association of customer IDs with customer-specific information, the point management server is preferably programmed to perform a search on the database using the customer ID received from the terminal for retrieving from the database customer-specific information associated with the received customer ID, to perform comparison of the customer-specific information received from the terminal with the customer-specific information retrieved from the database, and to issue the conversion allowance in response to a result of the comparison.

When the IC card contains a card ID, and the database contains sets of card IDs, customer IDs, and passwords, which are correlated with one another, it is preferable that the reader/writer obtains the card ID from the IC card to forward to the terminal, and the terminal is programmed to transmit the customer ID, the password, and the card ID obtained from the IC card, to the point management server, and that the point management server is programmed to determine whether the customer ID, the password, and the card ID received from the terminal are coincident with any of the sets of card IDs, customer IDs, and passwords, and to, when coincident, retrieve the customer-specific information from the database.

When the database contains an association of customer IDs with points, it is preferable that the electronic money server transmits transfer completion information to the point management server in response to completion of transferring the determined amount of electronic money, and the point management server updates the database in response to the transfer completion information received from the electronic money server.

In another aspect of the present invention, a computer program product is used for a cashback system including an IC card storing an amount of points, a terminal including a reader/writer accessible to the IC card, a point management server, and an electronic money server. The computer program product contains instructions for implementing the steps of:
providing a prompt on the terminal to input a customer ID identifying a customer, and a password in response to establishment of an access between the IC card and the terminal;
the terminal providing another prompt on the terminal to input customer-specific information in response to the identifier and the password being inputted;
transmitting the customer ID, the password, and the customer-specific information from the terminal to the point management server;
issuing a conversion allowance by the point management server when the customer is successfully authenticated with the customer ID, the password, and the customer-specific information;
determining an amount of electronic money for points selected to be converted by the customer in response to the conversion allowance by the electronic money server; and
transferring the determined amount of electronic money from the electronic money server to the IC card.

Preferably, the computer program product further contains instructions for implementing the steps of:
performing a search on the database using the customer ID received from the terminal for retrieving from the database customer-specific information associated with the received customer ID by the point management server; and
performing comparison of the customer-specific information received from the terminal with the customer-specific information retrieved from the database, the conversion allowance being issued in response to a result of the comparison.

When the IC card contains a card ID, and the database contains sets of card IDs, customer IDs, and passwords, which are correlated with one another, it is preferable that the computer program product further contains instructions for implementing the steps of:
allowing the reader/writer to obtain the card ID from the IC card to forward to the terminal,
transmitting the customer ID, the password, and the card ID obtained from the IC card, from the terminal to the point management server,
determining by the point management server whether the customer ID, the password, and the card ID received from the terminal are coincident with any of the sets of card IDs, customer IDs, and passwords, retrieving by the point management server the customer-specific information from the database when coincident.

When the database contains an association of customer IDs with points, it is preferable that the computer program product further contains instructions for implementing the steps of:
transmitting transfer completion information from the electronic money server to the point management server in response to completion of transferring the determined amount of electronic money, and
updating the database in response to the transfer completion information received from the electronic money server.

### BRIEF DESCRIPTION OF THE DRAWINGS

FIG. 1 is a block diagram showing a structure of a real-time cashback system in one embodiment of the present invention;

FIG. 2 is a block diagram showing a configuration of a point card;

FIG. 3 is a table showing contents of a dealer company management database 20 contained in a sales management server;

FIG. 4 is a table showing a configuration of a customer management database 30 contained in a client management server;

FIG. 5 is a table showing a point management database 40 contained in a point management server;

FIG. 6 is a table showing a configuration of an electronic money information database 60 contained in an electronic money dealing Web server;

FIG. 7 is a flowchart showing an exemplary operation of issuing “points”; and

FIG. 8 is a flowchart showing an exemplary operation for converting “points” into electronic money.

### DESCRIPTION OF THE PREFERRED EMBODIMENTS

Embodiments of the present invention will be described below in detail with reference to the attached drawings. In one embodiment, the present invention is applied to a real-time cashback system using point cards for a vehicle company. It should be understood that the present invention applies to any system adapted to the point system that allows converting points into electronic money.

### System Structure

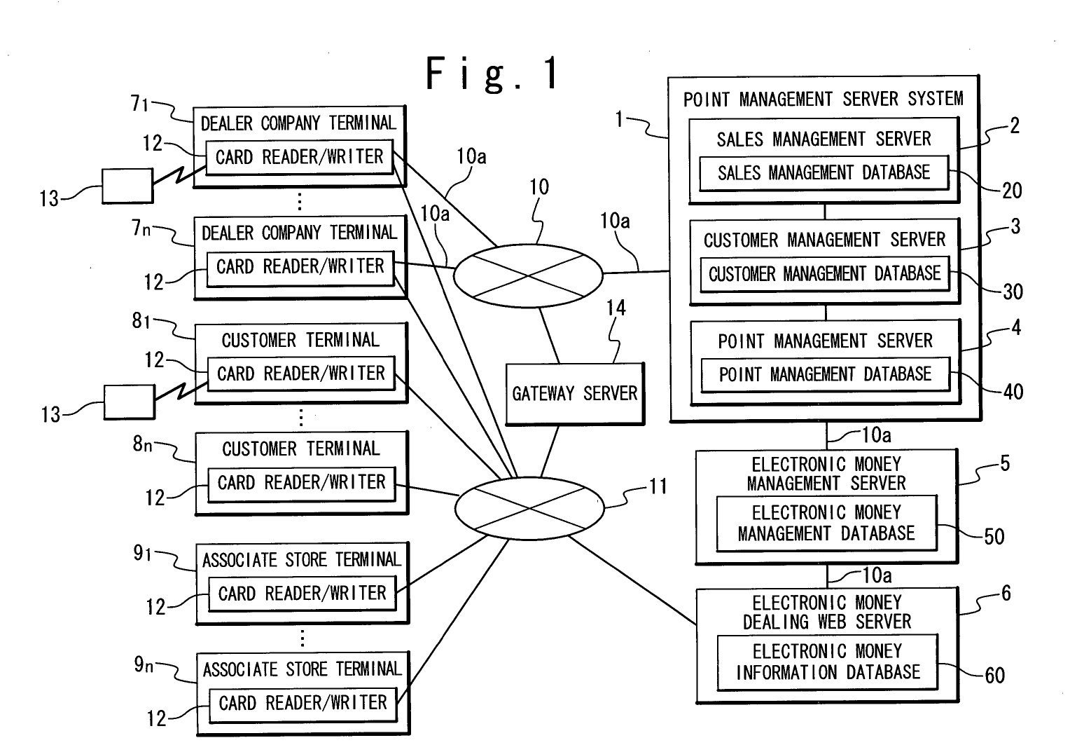

FIG. 1 is a block diagram illustrating an exemplary structure of the real-time cashback system in one embodiment. The real-time cashback system is provided with a point management server system 1, an electronic money management server 5, an electronic money dealing Web server 6, dealer company terminals 7₁ to 7ₙ, customer terminals 8₁ to 8ₙ, associate store terminals 9₁ to 9ₙ, a gateway server 14, an intranet 10; n indicates a natural number equal to or more than two. The dealer company terminals 7₁ to 7ₙ, the customer terminals 8₁ to 8ₙ, and the associate store terminals 9₁ to 9ₙ are each composed of a card reader/writer 12. The dealer company terminals 7₁ to 7ₙ are respectively provided for operation of dealer companies.

The point management server system 1 is provided for operation of the staff of a point management organization. The point management server system 1 is connected to the intranet 10 through a dedicated line 10a. The intranet 10 provides connections between the point management server system 1 and the dealer company terminals 7₁ to 7ₙ. The point management server system 1 is also connected to the electronic money management server 5.

The point management server system 1 is composed of a sales management server 2, a customer management server 3 and a point management server 4. The sales management server 2 is an information processor for managing information stored on the dealer company terminals 7₁ to 7ₙ. The sales management server 2 contains sales management database 20 in a storage device, and the sales management database 20 contains information on the dealer company terminals 7₁ to 7ₙ.

The customer management server 3 is an information processor for managing customer information. The customer management server 3 includes a customer management database 30 storing the customer information.

The point management server 4 is an information processor used for the management of points given to customers for the purchase of products and charged services. The point management server 4 contains a point management database 40 in a storage device for storing information on the point management.

The electronic money management server 5 is an information processor provided for operation of an entity that issues electronic money. The electronic money management server 5 is used for the management of electronic money; the electronic money management server 5 is responsive to information received from the point management server system 1 for issuing electronic money to the users of point cards 13. The electronic money management server 5 is connected through the dedicated line 10a to the point management server system 1 and connected through the dedicated line 10a to the electronic money dealing Web server 6. The electronic money management server 5 contains necessary information for the management of the electronic money in an electronic money management database 50.

The electronic money dealing Web server 6 is an information processor for providing reception services concerning electronic money. The electronic money dealing Web server 6 is designed to provide information on electronic money issued by the electronic management server 5. Accessing the electronic money dealing Web server 6 through the Internet 11 allows a user of a point card 13 to receive electronic money for the points accumulated in the point card 13. The electronic money dealing Web server 6 is connected through the dedicated line 10a to the electronic money management server 5, and also connected through the Internet 11 to the dealer company terminals 7₁ to 7ₙ, the customer terminals 8₁ to 8ₙ, and the associate store terminals 9₁ to 9ₙ. The electronic money dealing Web server 6 stores electronic money information database 60 in a storage device. The electronic money information database 60 contains information on electronic money available for each customer.

The dealer company terminals 7₁ to 7ₙ (which may be collectively denoted by numeral 7) are respectively provided for dealer companies, which provide vehicles and maintenance/inspection services. Each dealer company is equipped with at least one dealer company terminal 7, and the respective dealer company terminals 7 may be designed to share information. The dealer company terminals 7 each include a card reader/writer 12, an input device, a memory, a processor, a display and a communicator.

The card reader/writers 12 are used to access the point cards 13. The card reader/writers 12 are designed to desired information onto the point cards 13, and to read necessary information from the point cards 13. The card reader/writers 12 may have a connector for achieve connection with the point cards 13, and have an access to the point cards 13 when the point cards 13 are connected to the card reader/writers 12. Additionally, the card reader/writers 12 are designed to transmit the information received from the point cards 13 through the intranet 10 or Internet 11 to the point management server system 1. Finally, the card reader/writers 12 are designed to receive information to be written onto the point cards 13 from the point management server system 1 through the Internet 11, and to program the point cards 13 with the received information.

The customer terminals 8₁ to 8ₙ (which may be collectively denoted by numeral 8) are information processors provided for operation of the customers of the vehicle company. The customer terminals 8 are designed to be connectable to card reader/writers 12. The customer terminals 8 are connected through the Internet 11 to the electronic money dealing Web server 6.

The associate store terminals 9₁ to 9ₙ (which may be collectively denoted by numeral 9) are information processors provided for operation of the staff of dealer companies that do not sell vehicles, but are allowed to issue points according to contracts with the vehicle company. As is the case of the dealer company terminals 7, the associate store terminals 9 include card reader/writers 12. The associate store terminals 9 are connected through the Internet 11 to the electronic money dealing Web server 6.

The gateway server 14 is designed to provide a gateway between the intranet 10 and the Internet 11. The gateway server 14 is designed to perform protocol conversion between the intranet 10 and the Internet 11 so that data are exchanged therebetween. The gateway server 14 allows the customer terminals 8 and the associate store terminals 9 to function identically to the dealer company terminals 7 when being connected through the gateway server 14 to the point management server system 1.

The point cards 13 are used to accumulate points for the customers. The point cards 13 are issued to customers having had a contract with the vehicle company. When the point cards 13 are issued, personal information of the customers is registered into the customer management database 30 of the customer management server 3. When a customer contracts with the vehicle company upon purchasing a product, the information on the purchased product is transmitted to the sales management server 2 and stored in the sales management database 20.

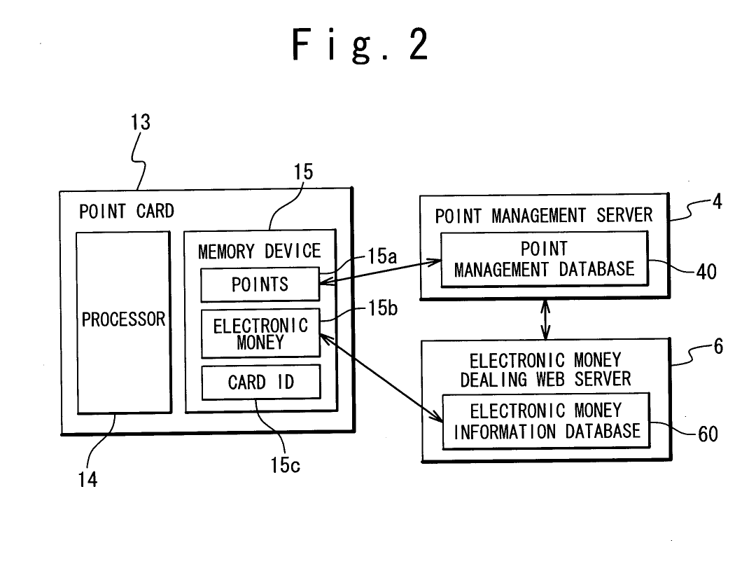

FIG. 2 is a block diagram illustrating an exemplary configuration of the point cards 13 in this embodiment. The point cards 13 are each composed of a processor 14, such as CPU (central processing unit), and a memory device 15, such as a semiconductor memory device. The memory device 15 contains point data 15a, electronic money data 15b and a card ID 15c. The point data 15a represents the amount of points gained by the customer. The electronic money data 15b represents the amount of electronic money. The card ID 15c is used for identifying the point cards 13.

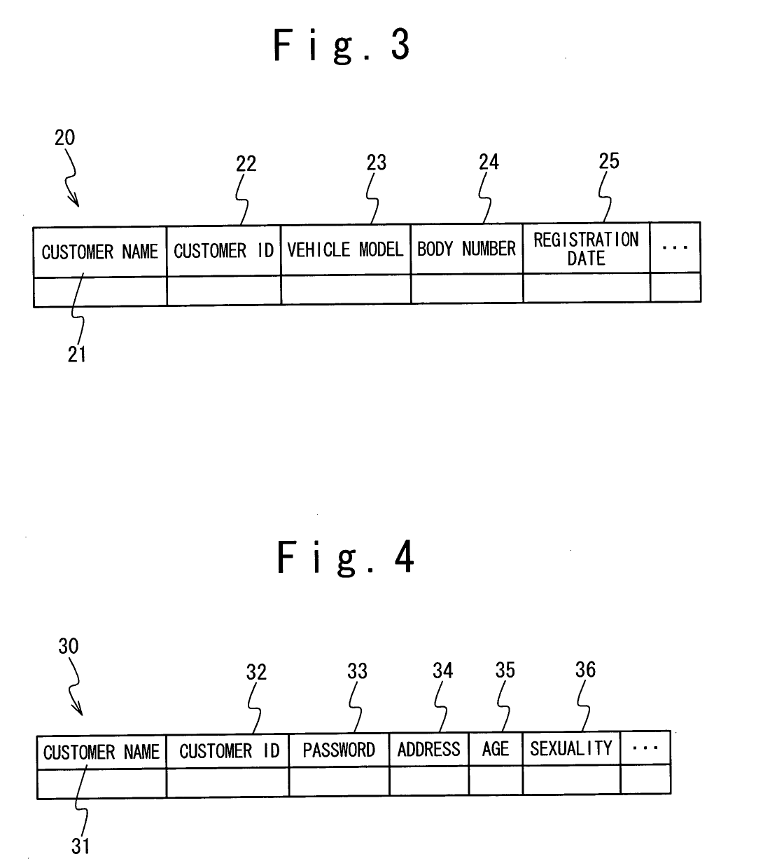

FIG. 3 is a table illustrating contexts of the sales management database 20 within the sales management server 2. The sales management database 20 contains customer name data 21, customer IDs 22, vehicle model data 23, body numbers 24, and registration date data 25, which are correlated with one another.

FIG. 4 is a table illustrating contexts of the customer management database 30 within the customer management server 3. The customer management database 30 contains customer name data 31, customer IDs 32, passwords 33, customer address data 34, customer age data 35 and sexuality data 36, which are correlated with one another.

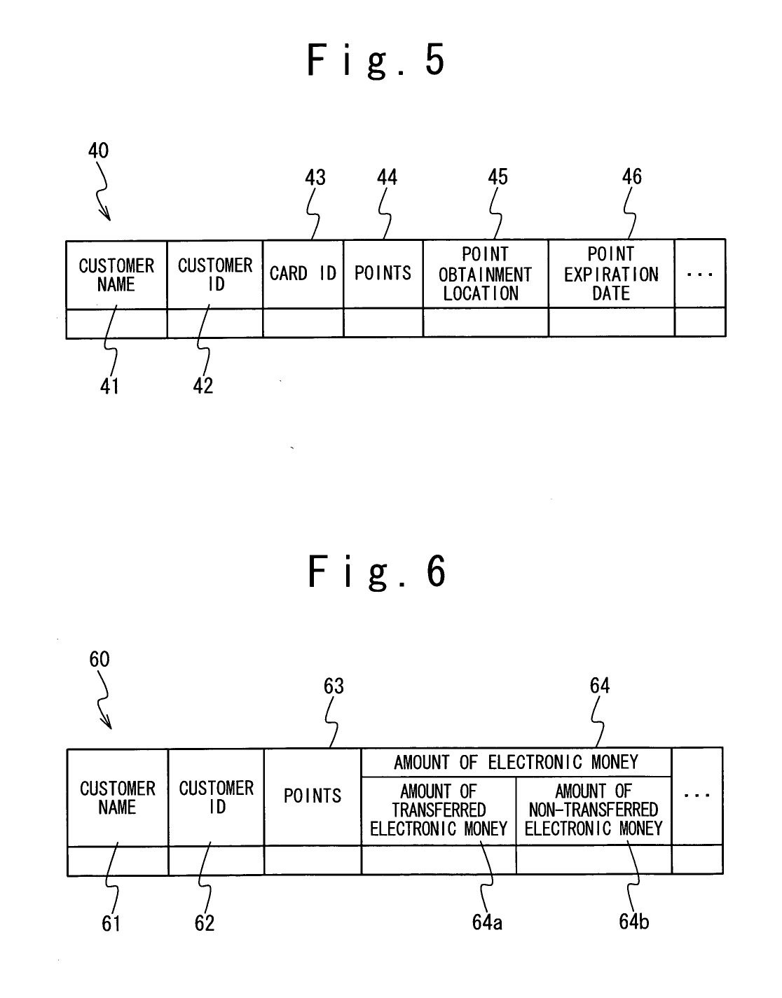

FIG. 5 is a table illustrating contexts of the point management database 40 within the point management server 4. The point management database 40 contains customer name data 41, customer IDs 42, card IDs 43, point data 44, point obtainment location information 45, and point expiration date data 46, which are correlated with one another.

FIG. 6 is a table illustrating contexts of the electronic money information database 60 within the electronic money dealing Web server 6. The electronic money information database 60 contains customer name data 61, client IDs 62, point data 63, and electronic money amount data 64, which are correlated with one another. The electronic money information 64 includes transferred electronic money amount data 64a and non-transferred electronic money amount data 64b. The transferred electronic money amount data 64a is representative of the amount of electronic money transferred to the associated point card 13. The non-transferred electronic money amount data 64a is, on the other hand, representative of the amount of electronic money available but not yet transferred to the associated point card 13

### System Operation

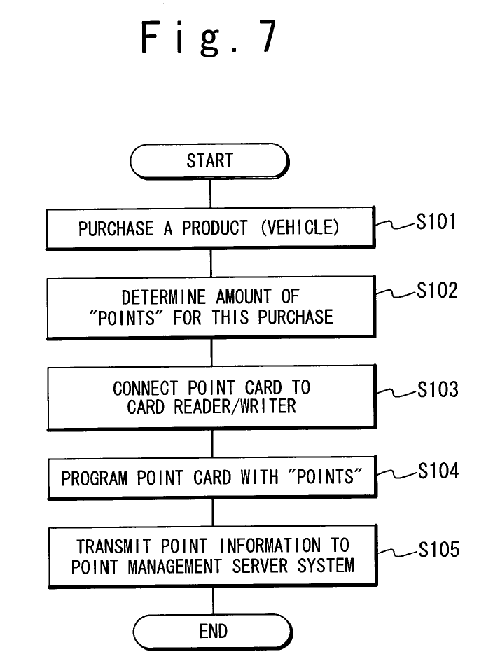

FIG. 7 is a flowchart showing an exemplary operation of issuing “points”. The operation described below assumes a case when a certain customer obtains “points” for purchasing a new vehicle from the dealer company by using the dealer company terminal 7₁. It should be understood, however, that “points” may be correspondingly obtained through purchasing vehicles or charged services from other dealer companies equipped with the dealer company terminals 7, implementing online shopping using the customer terminals 8, or purchasing products at the stores equipped with the associate store terminals 9.

At Step S101, the customer pays for the new vehicle to the dealer company.

At Step S102, in order to obtain points for the expense for the new vehicle, the customer operates the dealer company terminal 7₁ to access a point issue Web page dedicated to those having the point card contact with the vehicle company, the point issue Web page being provided by the point management server system 1. The point issue Web page prompts the customer to input the customer ID and the password. If the customer is successfully authenticated with the customer ID and the password, the point issue Web page allows the customer to login. The point issue Web page then prompts the customer to input the vehicle information on the purchased vehicle. The dealer company terminal 7₁ transmits the inputted vehicle information and the customer ID to the point management server system 1 through the intranet 10. The point management server system 1 extracts information on the purchased vehicle from a database containing information on vehicles in accordance with the received vehicle information and customer ID, and provides the extracted information for the point management server 4. The point management server 4 determines the amount of “points” to be given to the customer for the purchase of the vehicle on the basis of the received customer information and the information on the purchased vehicle. The rate of the “points” for the expense may not be constant; in special cases, such as a case when a sales boosting campaign is implemented or a case when a specific vehicle is purchased, the points more than those in normal cases may be issued.

At Step S103, the customer connects the point card 13 to the card reader/writer 12 associated with the dealer company terminal 7₁. The connection may be wirelessly achieved by approaching the point card 13 to the card reader/writer 12 or placing the point card 13 at a predetermined position of the card reader/writer 12. At Step S104, the dealer company terminal 7₁ programs the point card 13 to update the point data 15a in response to the amount of the “points” determined at Step S102.

After programming of the point card 13, at Step S105, the dealer company terminal 7₁ accesses the point management server system 1 through the intranet 10, and transmits the amount of the “points”, which is programmed onto the point card 13. The point management server system 1 stores the amount of the “points” received from the dealer company terminal 7₁ in the point management database 40 of the point management server 4.

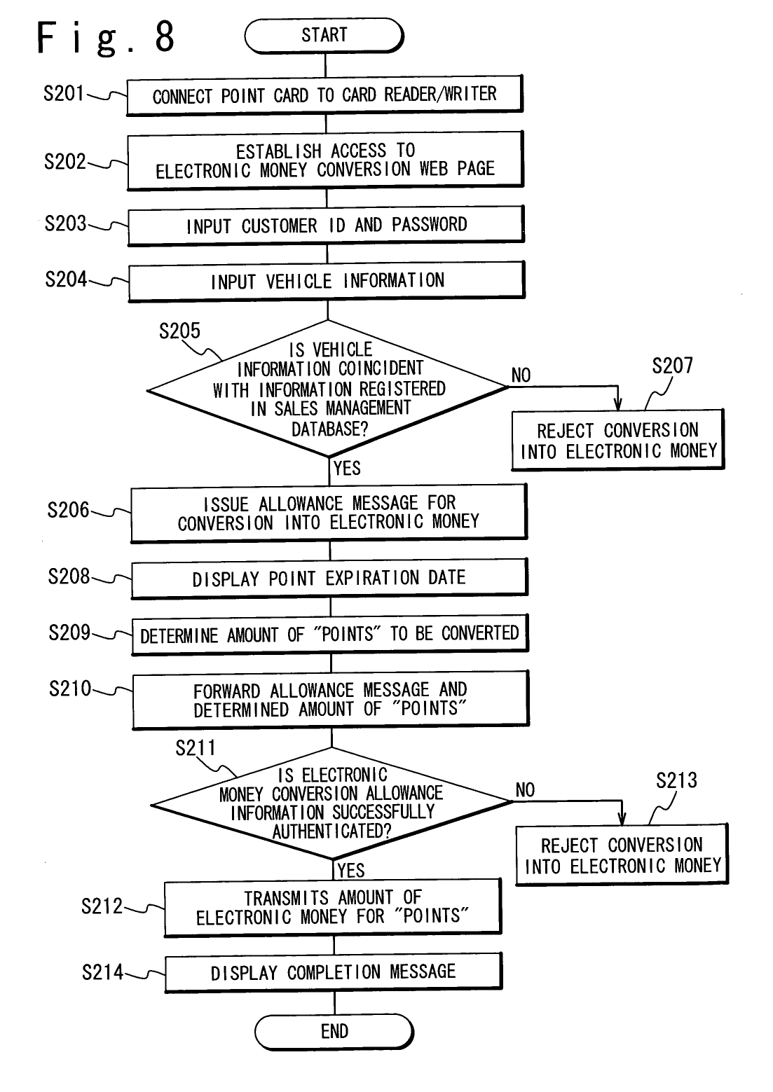

FIG. 8 is a flowchart illustrating an exemplary operation of converting “points” into electronic money. The operation described below assumes a case when the “points” are converted into electronic money by using the dealer company terminal 7₁. It should be understood, however, that “points” may be correspondingly converted by using the other dealer company terminals 7, the customer terminals 8, or the associate store terminals 9.

At Step S201, the customer connects the point card 13 to the card reader/writer 12 within the dealer company terminal 7₁, and thereby allows the dealer company terminal 7₁ to read the information stored in the point card 13. At Step S202, the customer uses the dealer company terminal 7₁ to access through the intranet 10 an electronic money conversion Web page provided by the point management server system 1.

At Step S203, the electronic money conversion Web page prompts the customer to input the customer ID and the password on the electronic money conversion Web page. The inputted customer ID and password are transmitted to the customer management server 3, and the customer is authenticated with the customer ID and password by using the customer management database 30.

When the customer is successfully authenticated, at Step S204, the electronic money conversion Web page then prompts the customer to input the vehicle information. The dealer company terminal 7₁ transmits the inputted vehicle information to the sales management server 2 through the intranet 10.

At Step S205, the point management server system 1 determines whether the vehicle information received from the dealer company terminal 7₁ is coincident with the vehicle information associated with the customer ID within the sales management database 20. If not coincident, an error message indicating that the conversion into the electronic money is not allowed is outputted to the dealer company terminal 7₁ at Step S207. If coincident, the process proceeds to Step S206, and an allowance message is outputted to the dealer company terminal 7₁ to report that the conversion of the “points” into electronic money is allowable.

Upon receiving the allowance message, the dealer company terminal 7₁ accesses to the point management server 4 at Step S208. The dealer company terminal 7₁ extracts the information associated with the relevant point card 13 from the point management database 40, and displays the amount of “points” on the electronic money conversion Web page. When the point expiration date is coming soon, the amount of the “points” and the point expiration date are displayed on the electronic money conversion Web page. This allows the customer to avoid the “points” becoming ineffective because of the expiration.

At Step S209, the electronic money conversion Web page prompts the customer to determine the amount of the “points” to be converted into electronic money on the basis of the displayed amount of the “points”. The amount of the “points” to be converted into electronic money can be arbitrarily determined in accordance with the customer's choice. The dealer company terminal 7₁ transmits the inputted amount of the “points” to be converted into electronic money to the point management server 4.

At Step S210, the point management server 4 transmits electronic money conversion allowance information to the electronic money management server 5 through the dedicated line 10a, the allowance information being composed of the allowance message of the conversion into the electronic money generated at Step S206 and the amount of the “points” to be converted into electronic money. Upon completing the transmission of the allowance information, the point management server 4 subtracts the amount of the “points” converted into the electronic money from that of the original “points” to update the point management database 40 with respect to the relevant point card 13.

At Step S211, the electronic money management server 5 authenticates the received electronic money conversion allowance information. The authentication is instantly implemented upon receiving the electronic money conversion allowance information. If the electronic money conversion allowance information is not successfully authenticated, an error message indicating that the conversion into the electronic money is not allowed is outputted to the dealer company terminal 7₁ at Step S213.

If the electronic money conversion allowance information is successfully authenticated, on the other hand, the process proceeds to Step S212. The electronic money management server 5 determines the amount of electronic money for the converted “points” in accordance with the received electronic money conversion allowance information, and transmits electronic money amount information representative of the determined amount of the electronic money to the electronic money dealing Web server 6. In response to the electronic money amount information, the electronic money dealing Web server 6 updates the electronic money information database 60, and transmits an update completion report to the electronic money management server 5.

At Step S214, the electronic money management server 5 generates a process completion message in response to the reception of the update completion report to transmit through the intranet 10 to the dealer company terminal 7₁. The dealer company terminal 7₁ displays a message indicating the completion of the conversion of the desired amount of the “points” into electronic money on the electronic money conversion Web page, in response to the reception of the process completion message. The electronic money conversion Web page then displays the amount of the electronic money stored in the relevant point card 13, and the amount of the electronic money that is stored in the electronic money dealing Web server 6 but not yet transferred to the relevant point card 13. The electronic money conversion Web page then prompts the relevant customer to indicate the amount of the electronic money to be transferred from the electronic money dealing Web server 6 to the relevant point card 13. When the customer selects the amount of the electronic money to be transferred, the dealer company terminal 7₁ transmits a request representative of the selected amount of the electronic money to the electronic money dealing Web server 6. Upon receiving the request from the dealer company terminal 7₁, the electronic money dealing Web server 6 transfers the amount of the electronic money to the relevant point card 13 in accordance with the received request, and updates the electronic money information database 60 in response to the amount of the transferred electronic money.

The operation described above effectively achieves real-time cashback for “points”. This is advantageous for the customers, because no expiration date is determined for electronic money. Conventionally, points are ineffective after the expiration date; however, the real-time cashback system in this embodiment allows customers to convert “points” into electronic money, and to thereby avoid “points” being lost because of the expiration.

Although the invention has been described in its preferred form with a certain degree of particularity, it is understood that the present disclosure of the preferred form has been changed in the details of construction and the combination and arrangement of parts may be resorted to without departing from the scope of the invention as hereinafter claimed.

1. A cashback system comprising:
an IC card storing point data representative of an amount of points used for a point system, and electronic money data representative of an amount of electronic money;
a terminal including a reader/writer accessible to said IC card;
a point management server; and
an electronic money server,
wherein said terminal is programmed to provide a prompt to input a customer ID identifying a customer, and a password in response to establishment of an access between said IC card and said terminal, to provide another prompt to input customer-specific information in response to said identifier and said password being inputted, and to transmit said customer ID, said password, and said customer-specific information to said point management server,
wherein said point management server is programmed to issue a conversion allowance when said customer is successfully authenticated with said customer ID, said password, and said customer-specific information, and to transmit said conversion allowance to said electronic server, and
wherein said electronic money server is programmed to determine an amount of electronic money for points selected to be converted by said customer in response to said conversion allowance, and to transfer said determined amount of electronic money to said IC card.

2. The cashback system according to claim 1, wherein said point management server includes a database containing an association of customer IDs with customer-specific information,
wherein said point management server is programmed to perform a search on said database using said customer ID received from said terminal for retrieving from said database customer-specific information associated with said received customer ID, to perform comparison of said customer-specific information received from said terminal with said customer-specific information retrieved from said database, and to issue said conversion allowance in response to a result of said comparison.

3. The cashback system according to claim 2, wherein said IC card contains a card ID,
wherein said database contains sets of card IDs, customer IDs, and passwords, which are correlated with one another,
wherein said reader/writer obtains said card ID from said IC card to forward to said terminal,
wherein said terminal is programmed to transmit said customer ID, said password, and said card ID obtained from said IC card, to said point management server, and
wherein said point management server is programmed to determine whether said customer ID, said password, and said card ID received from said terminal are coincident with any of said sets of card IDs, customer IDs, and passwords, and to, when coincident, retrieve said customer-specific information from said database.

4. The cashback system according to claim 2, wherein said database contains an association of customer IDs with points,
wherein said electronic money server transmits transfer completion information to said point management server in response to completion of transferring said determined amount of electronic money, and
wherein said point management server updates said database in response to said transfer completion information received from said electronic money server.

5. A computer program product used for a cashback system including an IC card storing an amount of points, a terminal including a reader/writer accessible to said IC card, a point management server, and an electronic money server, said product containing instructions for implementing the steps of:
providing a prompt on said terminal to input a customer ID identifying a customer, and a password in response to establishment of an access between said IC card and said terminal;
providing another prompt on said terminal to input customer-specific information in response to said identifier and said password being inputted;
transmitting said customer ID, said password, and said customer-specific information from said terminal to said point management server;
issuing a conversion allowance by said point management server when said customer is successfully authenticated with said customer ID, said password, and said customer-specific information;
transmitting said conversion allowance from said point management server to said electronic money server;
determining an amount of electronic money for points selected to be converted by said customer in response to said conversion allowance by said electronic money server; and
transferring said determined amount of electronic money from said electronic money server to said IC card.

6. The computer program product according to claim 5, wherein said point management server includes a database, and said product further containing instructions for implementing the steps of:
performing a search on said database using said customer ID received from said terminal for retrieving from said database customer-specific information associated with said received customer ID by said point management server; and
performing comparison of said customer-specific information received from said terminal with said customer-specific information retrieved from said database,
wherein said conversion allowance is issued in response to a result of said comparison.

7. The computer program product according to claim 6, wherein said IC card contains a card ID, and said database contains sets of card IDs, customer IDs, and passwords, which are correlated with one another, and
said computer program product further containing instructions for implementing the steps of:
allowing said reader/writer to obtain said card ID from said IC card to forward to said terminal,
transmitting said customer ID, said password, and said card ID obtained from said IC card, from said terminal to said point management server,
determining by said point management server whether said customer ID, said password, and said card ID received from said terminal are coincident with any of said sets of card IDs, customer IDs, and passwords, retrieving by said point management server said customer-specific information from said database when coincident.

8. The computer program product according to claim 6, wherein said database contains an association of customer IDs with points,
said computer program product further containing instructions for implementing the steps of:
transmitting transfer completion information from said electronic money server to said point management server in response to completion of transferring said determined amount of electronic money, and
updating said database in response to said transfer completion information received from said electronic money server.

9. A method for operating a cashback system including an IC card storing an amount of points, a terminal including a reader/writer accessible to said IC card, a point management server, and an electronic money server, said method comprising:
providing a prompt on said terminal to input a customer ID identifying a customer, and a password in response to establishment of an access between said IC card and said terminal;
providing another prompt on said terminal to input customer-specific information in response to said identifier and said password being inputted;
transmitting said customer ID, said password, and said customer-specific information from said terminal to said point management server;
issuing a conversion allowance by said point management server when said customer is successfully authenticated with said customer ID, said password, and said customer-specific information;
transmitting said conversion allowance from said point management server to said electronic money server;
determining an amount of electronic money for points selected to be converted by said customer in response to said conversion allowance by said electronic money server; and
transferring said determined amount of electronic money from said electronic money server to said IC card.

10. The method according to claim 9, wherein said point management server includes a database, and said method further comprising:
performing a search on said database using said customer ID received from said terminal for retrieving from said database customer-specific information associated with said received customer ID by said point management server; and
performing comparison of said customer-specific information received from said terminal with said customer-specific information retrieved from said database,
wherein said conversion allowance is issued in response to a result of said comparison.

11. The method according to claim 10, wherein said IC card contains a card ID, and said database contains sets of card IDs, customer IDs, and passwords, which are correlated with one another, and
said method further comprising the steps of:
allowing said reader/writer to obtain said card ID from said IC card to forward to said terminal,
transmitting said customer ID, said password, and said card ID obtained from said IC card, from said terminal to said point management server,
determining by said point management server whether said customer ID, said password, and said card ID received from said terminal are coincident with any of said sets of card IDs, customer IDs, and passwords, retrieving by said point management server said customer-specific information from said database when coincident.

12. The method according to claim 10, wherein said database contains an association of customer IDs with points,
said method further comprising the steps of:
transmitting transfer completion information from said electronic money server to said point management server in response to completion of transferring said determined amount of electronic money, and
updating said database in response to said transfer completion information received from said electronic money server.
